(19) United States
(12) Patent Application Publication
(10) Pub. No.: US 2025/0054117 A1
(43) Pub. Date: Feb. 13, 2025

(54) DEMOIRÉ USING MULTIPLE CAMERAS

(71) Applicant: SAMSUNG ELECTRONICS CO., LTD., SUWON-SI (KR)

(72) Inventors: Gil Shapira, Tel-Aviv (IL); Ishay Goldin, Tel-Aviv (IL); Niv Zehngut, Tel-Aviv (IL); David Tal, Tel-Aviv (IL)

(21) Appl. No.: 18/447,743

(22) Filed: Aug. 10, 2023

(51) Int. Cl. G06T 5/00; G06T 5/50; G06T 7/10; G06V 10/24

(52) U.S. Cl. CPC G06T 5/80; G06T 5/50; G06T 7/10; G06V 10/24; G06T 2207/20084; G06T 2207/20132

(57) ABSTRACT

Systems and methods for image processing (e.g., image correction) are described. Embodiments of the present disclosure include image processing techniques that reduce or remove Moiré patterns by leveraging low resolution images (e.g., images captured using low resolution sensors, such as an ultra-wide camera). For instance, an image including a Moiré pattern may be corrected based on a second image having a low resolution. In one example, a device may capture a high resolution image that includes a Moiré pattern. The device may also capture a low resolution image that is aligned with the high resolution image and used to correct (e.g., remove) the Moiré pattern. In some embodiments, the systems and techniques described herein may be implemented in real-time on a user device (e.g., that includes a high resolution image sensor and a low resolution image sensor) for efficient and effective correction of Moiré patterns in image/video capture applications.

### BACKGROUND

The following relates generally to image processing, and more specifically to image correction (e.g., removal of Moiré patterns in captured images).

The use of image capture devices, which may include still image cameras, moving image cameras or other electronic devices that include cameras or image sensors, has rapidly increased in recent years along with advancements in camera technology. Digital cameras may use image sensors (e.g., to capture images) and image signal processors (e.g., to process the captured images).

Image processing may generally refer to systems and techniques for editing an image (e.g., using algorithms or processing networks). For instance, image processing techniques that may be performed on captured images may include image sharpening, noise reduction, color control, image segmentation, object detection, and depth estimation, among various other specialized tasks. Such image processing techniques may be implemented for various applications such as image enhancement, image editing, robot navigation, etc.

In some cases, image capture may result in the occurrence (e.g., or appearance) of Moiré patterns. Moiré patterns, which may exhibit a wavy or watered appearance, may appear in digital images as a series of interference fringes or distortion effects. Such patterns may occur when repetitive details (e.g., in a scene/image to be captured) occur at a frequency that approaches the sensor's resolution limit. For instance, in the context of screen captures (e.g., secondary images that are captured from other display screens), the pattern of pixels on a screen may interact negatively with a pattern of sensors in the image capture device, which may lead to Moiré patterns present in a captured image.

Some image processing systems may attempt to mitigate the effect of Moiré patterns via a series of digital image processing techniques. However, such techniques may demand significant computational resources, which can introduce additional latency (e.g., particularly in real-time applications). Furthermore, some techniques for reducing Moiré patterns may compromise the quality of the final image, for example, by blurring or otherwise altering finer details of the image. Accordingly, there is a need in the art for more effective and efficient image processing techniques (e.g., for handling Moiré patterns resulting from image capture of display screens).

### SUMMARY

The present disclosure describes systems and methods for image processing. Embodiments of the present disclosure include image processing techniques that reduce or remove Moiré patterns by leveraging low resolution images (e.g., images captured using low resolution sensors, such as an ultra-wide camera). For instance, an image including a Moiré pattern may be corrected based on a second image having a low resolution. In one example, a device may capture a high resolution image that includes a Moiré pattern, and the device may capture a low resolution image that is aligned with the high resolution image and used to correct (e.g., remove) the Moiré pattern. In some embodiments, the systems and techniques described herein may be implemented in real-time on a user device (e.g., that includes a high resolution image sensor and a low resolution image sensor) for efficient and effective correction of Moiré patterns in image/video capture applications.

Accordingly, a method, apparatus, non-transitory computer readable medium, and system for image processing (i.e., for image correction) are described. One or more aspects of the method, apparatus, non-transitory computer readable medium, and system include identifying a first image and a second image, wherein the first image comprises a Moiré pattern; aligning the first image and the second image; and generating a corrected image by removing the Moiré pattern from the first image based on the second image and the alignment.

Additionally, an apparatus, system, and method for image processing are described. One or more aspects of the apparatus, system, and method include at least one processor; at least one memory storing instructions and in electronic communication with the at least one processor; a first image sensor configured to obtain a first image having a first resolution; a second image sensor configured to obtain a second image having a second resolution different than the first resolution; and a correction component configured to generate a corrected image by removing a Moiré pattern from the first image based on the second image.

### BRIEF DESCRIPTION OF THE DRAWINGS

FIG. 1 shows an example of an image processing system according to aspects of the present disclosure.

FIG. 2 shows an example of a computing apparatus according to aspects of the present disclosure.

FIGS. 3 through 4 show examples of an image processing system according to aspects of the present disclosure.

FIG. 5 shows an example of a correction component according to aspects of the present disclosure.

FIG. 6 shows an example of an image correction process according to aspects of the present disclosure.

FIG. 7 shows an example of a method for image processing according to aspects of the present disclosure.

### DETAILED DESCRIPTION

Image processing technologies have become increasingly important in various fields including photography, video processing, computer vision, and more. Image processing or digital image processing refers to the use of a computer to edit a digital image (e.g., or synthesize an image) using an algorithm or a processing network. Accordingly, image processing techniques may be implemented to enhance (e.g., correct or improve) images, to remove undesirable artifacts, etc.

For example, in some cases, image capture may result in the occurrence (e.g., or appearance) of undesirable image artifacts, such as Moiré patterns. Conventional approaches to handling image artifacts, such as Moiré patterns, often require significant computational resources, which can introduce additional latency, increase device power consumption, etc. For instance, other existing approaches may rely on inefficient pre-processing, complex/highly trained neural network post-processing, etc.). Additionally or alternatively, conventional approaches may compromise the quality of the final image by blurring or otherwise altering finer details of the image (e.g., in areas surrounding present Moiré pattern artifacts and/or in other areas of an image that may be otherwise not impacted by the appearance of a Moiré pattern).

As an example, conventional approaches to Moiré pattern removal (e.g., de-Moiréing) may use large models trained to remove Moiré patterns from single contaminated image frames. Such models may be trained with Moiré pattern-free images and Moiré pattern present images to remove Moiré patterns in new input images (e.g., however such models may be large and demand complex training and compute operations). That is, a neural network or a machine learning model may be used to generate edited images based on a source image and user input. For example, a neural network may obtain an image from a user and add or modify certain content associated with the image, such as remove or modify image content corresponding to a Moiré pattern. However, as Moiré patterns are often complicated multi-frequency artifacts, such models have large computational complexity (e.g., and may often produce undesirable or unsatisfactory results).

Therefore, as described in more detail herein, the present disclosure addresses and mitigates the presence of image artifacts, such as Moiré patterns, in an effective and efficient manner (e.g., via innovative leveraging of low resolution images). Example embodiments of the present disclosure include aligning low resolution image frames (e.g., which do not include Moiré patterns, or include reduced Moiré patterns) with image frames including Moiré patterns, such that a corrected image may be generated based at least in part on the alignment. Such leveraging of low resolution frames (e.g., Moiré-free frames or Moiré-reduced frames from an Ultra-wide camera) may simplify image processing tasks, enable implementation of smaller image processing models with better image quality output, etc. (e.g., which may enable implementation of such systems and methods in real-time on mobile phones or other computing-limited devices).

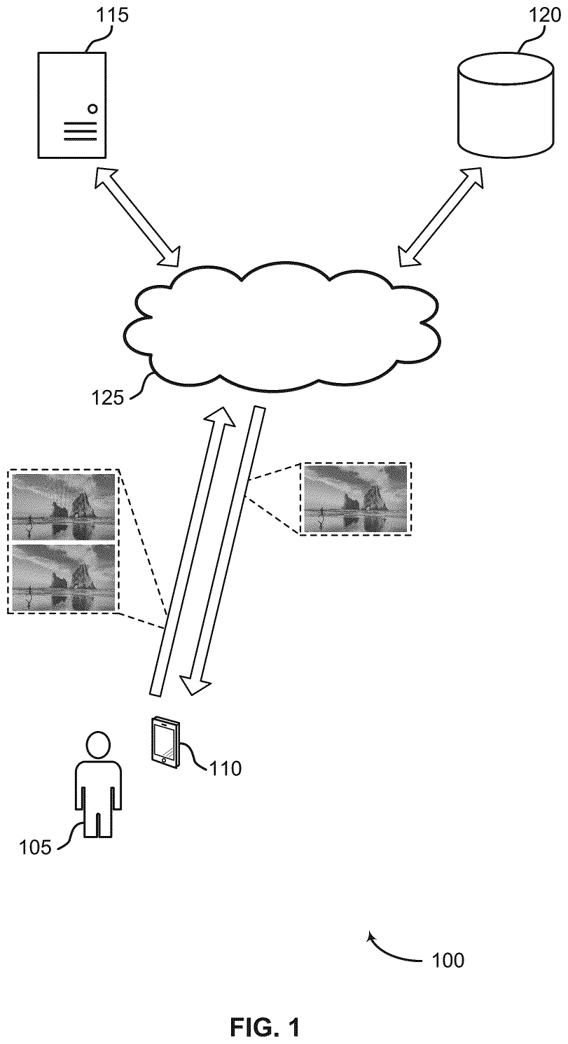

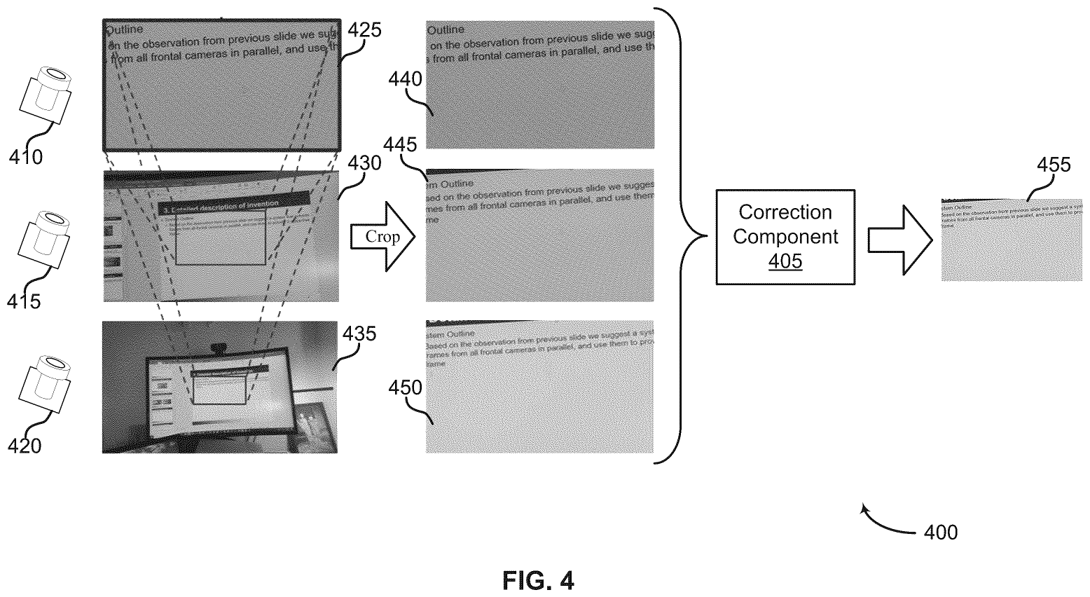

Embodiments of the present disclosure can be used in the context of various image processing applications (e.g., such as image editing and image correction applications). For example, an image processing system based on the present disclosure may take an image with a Moiré pattern and use images with different optical specifications to generate corrected output images. Example embodiments of the present disclosure in the context of image processing systems are described with reference to FIGS. 1 through 3. Details regarding example image correction processes (e.g., example Moiré pattern removal processes) are then described with reference to FIGS. 4 through 7.

### Image Processing Systems

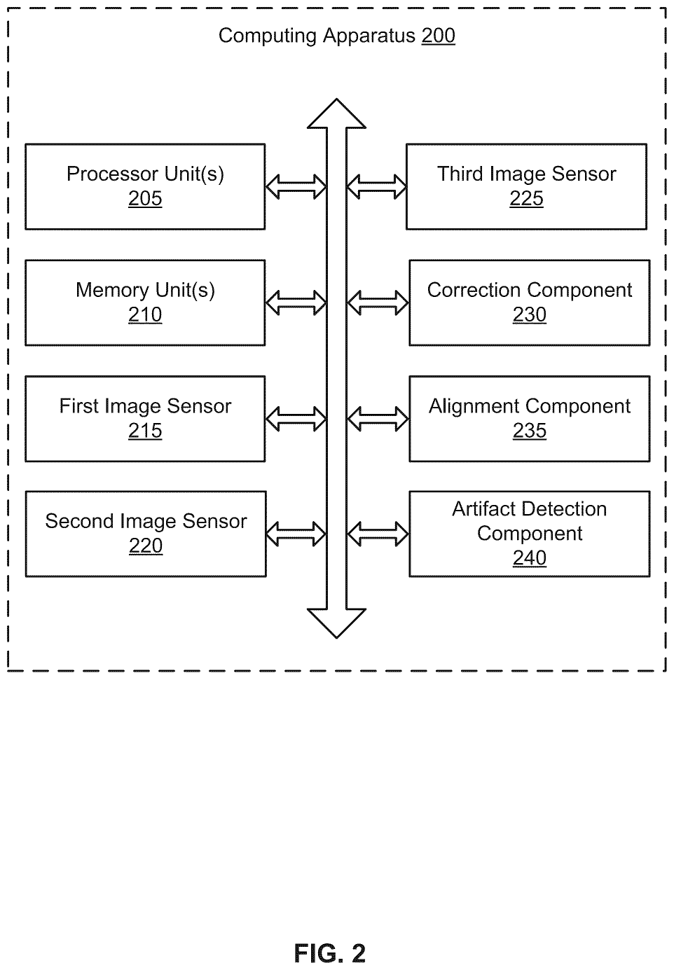

FIG. 1 shows an example of an image processing system 100 according to aspects of the present disclosure. The example shown includes user 105, computing apparatus 110, server 115, database 120, and cloud 125. Image processing system 100 is an example of, or includes aspects of, the corresponding element described with reference to FIG. 2. Image processing system 100 may implement one or more aspects of the present disclosure to remove image artifacts (e.g., Moiré patterns) to provide high quality output images. In some embodiments, a user may obtain/provide image(s), via computing apparatus 110, that may be processed to reduce or remove Moiré patterns. For example, in some embodiments, image processing system 100 may be implemented to remove Moiré patterns otherwise present in images or frames captured from other display screens, such as images captured of computer screens, television screens, etc.

In some cases, computing apparatus 110 may be a user device. A user device may include a computing device, personal computer, laptop computer, mainframe computer, palmtop computer, personal assistant, mobile device, or any other suitable processing apparatus. In some examples, the user device includes software that incorporates image processing applications (e.g., a Moiré pattern removal application). In some implementations, the image processing application may be performed entirely on the user computing apparatus 110. In some implementations, the image processing application may either include or communicate with server 115 (e.g., in some cases, the image processing application implemented via computing apparatus 110 may include functions of server 115).

In many cases, computing apparatus 110 may include multiple image sensors (e.g., cameras). For example, computing apparatus 110 may include image sensors of varying resolution, focal length, etc. (e.g., for improving zoom performance, for enhancing image quality, for leveraging physical properties of different image sensors, etc.). For instance, computing apparatus 110 may include a high resolution image sensor (e.g., a telephoto camera), a standard image sensor (e.g., a camera), a low resolution image sensor (e.g., a wide angle camera), etc. According to the techniques and systems described herein, low resolution image sensors (e.g., wide angle cameras with a larger field of view) may be used to reduce or remove Moiré patterns, as described in more detail herein.

In the example of FIG. 1, computing apparatus 110 may include a high resolution image sensor and a low resolution image sensor. Accordingly, a user may provide images (such as a high-resolution image and a low-resolution image) in an image processing system 100. In some aspects, the low-resolution image is captured using a camera with low optical resolution (e.g., an ultra-wide camera) and a high-resolution image is captured using a camera with high-resolution (e.g., a tele-lens camera). In some examples, the low-resolution image and the high-resolution image may be passed or transmitted to server 115, through cloud 125, via a user interface on computing apparatus 110.

As an example shown in FIG. 1, the user-provided high-resolution image may include a Moiré pattern. In some aspects, a Moiré pattern may be a complex multi-frequency artifact. For instance, in some cases, Moiré patterns may include, or refer to, large-scale interference patterns that can be produced when a partially opaque ruled pattern with transparent gaps is overlaid on another similar pattern.

In the example of FIG. 1, the low-resolution image and the high-resolution image may be captures of a same scene, and thus include similar content (e.g., a person running on a beach including two large rocks). In some examples, server 115 generates an output image (a corrected image) as shown in FIG. 1, that does not include the Moiré pattern (or includes a reduced Moiré pattern). That is, the server 115 may provide the user device (e.g., via cloud 125) with an edited image based on the input images, where the output image is a de-Moiréd image (e.g., a high-resolution image, with a reduced or removed Moiré pattern, that includes some original content of the input images provided by user 105).

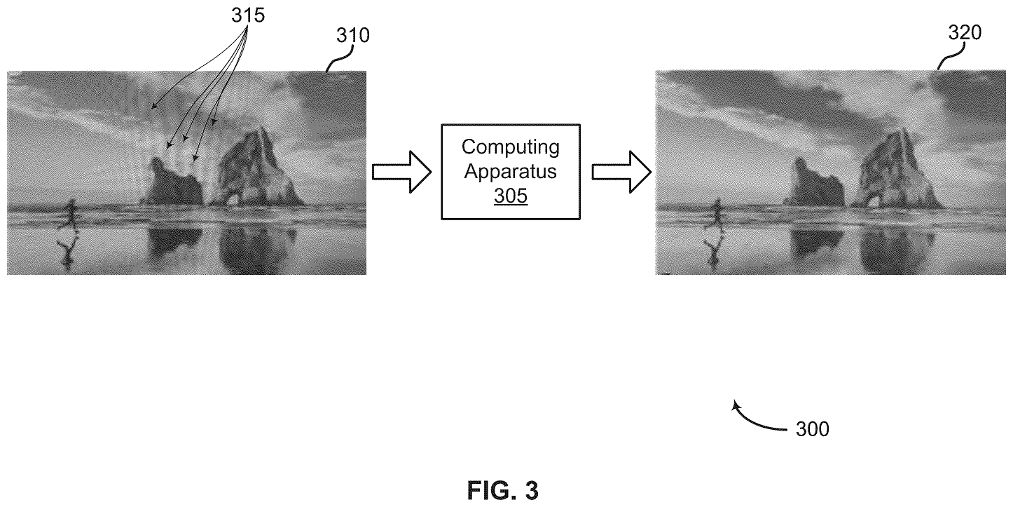

According to some aspects, computing apparatus 110 identifies a first image and a second image, where the first image includes a Moiré pattern. For example, the first image may include a high-resolution image and the second image may include a low-resolution image. In the image processing system 100, computing apparatus 110 and/or server 115 may identify region(s) of the high-resolution image that include (e.g., or present) the Moiré pattern, and computing apparatus 110 and/or server 115 may combine (e.g., merge, replace, etc.) the identified Moiré pattern region (of the high-resolution image) with the content from the corresponding region of the low-resolution image. Further, image processing system 100 may use an algorithm to generate a high-resolution output image that corrects the Moiré pattern in the user-provided high-resolution image based on content in the low-resolution image. Computing apparatus 110 is an example of, or includes aspects of, the corresponding element described with reference to FIGS. 2 and 3.

A user interface may enable user 105 to interact with user device. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user computing apparatus 110 and rendered locally by a browser.

A server 115 provides one or more functions to users 105 linked by way of one or more of the various networks. In some cases, server 115 includes a single microprocessor board, which includes a microprocessor responsible for controlling all aspects of server 115. In some cases, a server 115 uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, server 115 is configured to send and receive hypertext markup language (HTML) formatted files (e.g., for displaying web pages).

In various embodiments, a server 115 comprises a general purpose computing device, a personal computer, a laptop computer, a mainframe computer, a supercomputer, or any other suitable processing apparatus. For example, server 115 may include a processor unit, a memory unit, an I/O module, etc. In some aspects, server 115 may include a computer implemented network. Server 115 may communicate with database 120 via cloud 125. In some cases, the architecture of the image processing network may be referred to as a network or a network model.

Database 120 is an organized collection of data. For example, a database 120 stores data in a specified format known as a schema. A database 120 may be structured as a single database 120, a distributed database 120, multiple distributed databases 120, or an emergency backup database 120. In some cases, a database 120 controller may manage data storage and processing in a database 120. In some cases, user 105 interacts with database 120 controller. In other cases, database 120 controller may operate automatically without user 105 interaction.

Cloud 125 is a computer network configured to provide on-demand availability of computer system resources, such as data storage and computing power. In some examples, cloud 125 provides resources without active management by user 105. The term cloud 125 is sometimes used to describe data centers available to many users 105 over the Internet. Some large cloud 125 networks have functions distributed over multiple locations from central servers 115. A server 115 is designated an edge server 115 if it has a direct or close connection to a user 105. In some cases, cloud 125 is limited to a single organization. In other examples, cloud 125 is available to many organizations. In one example, cloud 125 includes a multi-layer communications network comprising multiple edge routers and core routers. In another example, cloud 125 is based on a local collection of switches in a single physical location.

FIG. 2 shows an example of a computing apparatus 200 according to aspects of the present disclosure. Computing apparatus 200 is an example of, or includes aspects of, the corresponding element described with reference to FIGS. 1 and 3. For example, in some implementations, computing apparatus 200 may be implemented as user computing apparatus 110 or as server 115. In some implementations, computing apparatus 200 may be implemented via a combination of user computing apparatus 110, server 115, database 120, and cloud 125 (e.g., where components of computing apparatus 200, and operations performed by computing apparatus 200, may be distributed across the user device 110, server 115, database 120, and cloud 125 according to various configurations). As described in more detail herein, computing apparatus 200 may be implemented for various image editing applications (e.g., for image correction).

According to various embodiments of the present disclosure, computing apparatus 200 includes processor unit 205, memory unit 210, first image sensor 215, second image sensor 220, third image sensor 225, correction component 230, alignment component 235, and artifact detection component 240.

Processor unit 205 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor unit 205 is configured to operate a memory array using a memory controller. In other cases, a memory controller is integrated into processor unit 205. In some cases, processor unit 205 is configured to execute computer-readable instructions stored in a memory to perform various functions. In some embodiments, processor unit 205 includes special purpose components for modem processing, baseband processing, digital signal processing, or transmission processing.

Examples of a memory unit 210 include random access memory (RAM), read-only memory (ROM), or a hard disk. Examples of memory unit 210 include solid state memory and a hard disk drive. In some examples, memory unit 210 is used to store computer-readable, computer-executable software including instructions that, when executed, cause a processor unit 205 to perform various functions described herein. In some cases, the memory unit 210 contains, among other things, a basic input/output system (BIOS) which controls basic hardware or software operation such as the interaction with peripheral components or devices. In some cases, a memory controller operates memory cells of memory unit 210. For example, the memory controller can include a row decoder, column decoder, or both. In some cases, memory cells within a memory unit 210 store information in the form of a logical state. In some aspects, at least one memory storing instructions and in electronic communication with the at least one processor.

According to some aspects, computing apparatus 200 uses at least one processor included in processor unit 205 to execute instructions stored in at least one memory device included in memory unit 210 to perform operations.

According to some aspects, first image sensor 215 obtains the first image using a first sensor having a first resolution. First image sensor 215 is an example of, or includes aspects of, the corresponding element described with reference to FIG. 4.

According to some aspects, second image sensor 220 obtains the second image using a second sensor having a second resolution less than the first resolution. Second image sensor 220 is an example of, or includes aspects of, the corresponding element described with reference to FIG. 4.

According to some aspects, third image sensor 225 identifies a third image. According to some aspects, third image sensor 225 is configured to obtain a third image having a third resolution, wherein the alignment component 235 is configured to align the third image with the first image and the second image, and wherein the corrected image is generated based on the third image. Third image sensor 225 is an example of, or includes aspects of, the corresponding element described with reference to FIG. 4.

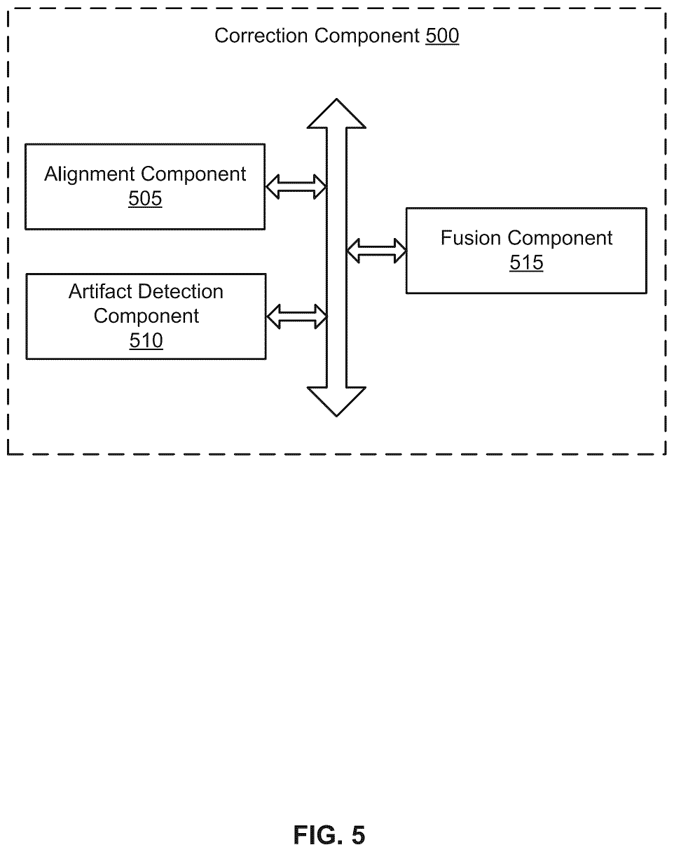

According to some aspects, correction component 230 generates a corrected image by removing the Moiré pattern from the first image based on the second image and the alignment. In some examples, correction component 230 provides the first image and the second image to a correction neural network, where the corrected image is generated by the correction neural network. According to some aspects, correction component 230 is configured to generate a corrected image by removing a Moiré pattern from the first image based on the second image. In some aspects, the correction component 230 includes a correction neural network. Correction component 230 is an example of, or includes aspects of, the corresponding element described with reference to FIGS. 4 and 5.

In some cases, correction component 500 includes a computer implemented neural network (NN) for image correction (e.g., in some aspects, correction component 500 may include an artificial neural network (ANN)). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the neural network. Hidden representations are machine-readable data representations of an input that are learned from a neural network's hidden layers and are produced by the output layer. As the neural network's understanding of the input improves as it is trained, the hidden representation is progressively differentiated from earlier iterations.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

A convolutional neural network (CNN) is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

According to some embodiments of the present disclosure, correction component 230, alignment component 235, and artifact detection component 240 are different components. The term ‘component’ is used to partition the functionality enabled by the processor(s) and the executable instructions included in the computing device used to implement computing apparatus 200. The partitions may be implemented physically, such as through the use of separate circuits or processors for each component, or may be implemented logically via the architecture of the code executable by the processors.

According to some aspects, alignment component 235 aligns the first image and the second image. In some examples, alignment component 235 crops the second image based on a field of view of the first image to obtain a cropped second image, where the alignment is based on the cropped second image. In some examples, alignment component 235 generates an alignment map between pixels of the first image and pixels of the second image, where the corrected image is generated based on the alignment map.

In some examples, alignment component 235 generates an aligned first image based on the first image. In some examples, alignment component 235 generates an aligned second image based on the second image, where the corrected image is generated based on the aligned first image and the aligned second image. In some examples, alignment component 235 aligns the third image with the first image and the second image, where the corrected image is generated based on the third image. According to some aspects, alignment component 235 is configured to align the first image and the second image, wherein the corrected image is generated based on the alignment. Alignment component 235 is an example of, or includes aspects of, the corresponding element described with reference to FIG. 5.

According to some aspects, artifact detection component 240 detects the Moiré pattern in the first image, where the corrected image is generated based on the detection of the Moiré pattern. In some examples, artifact detection component 240 obtains a set of frames of a video, where the set of frames includes the first image. In some examples, artifact detection component 240 selects the first image from the set of video frames based on a detection frequency, where the Moiré pattern is detected based on the selection.

According to some aspects, artifact detection component 240 is configured to detect the Moiré pattern in the first image, wherein the corrected image is generated based on the detection of the Moiré pattern. Artifact detection component 240 is an example of, or includes aspects of, the corresponding element described with reference to FIG. 5.

### Image Correction Processes

FIG. 3 shows an example of an image processing system 300 according to aspects of the present disclosure. Image processing system 300 is an example of, or includes aspects of, the corresponding element described with reference to FIG. 4. In one aspect, image processing system 300 includes computing apparatus 305, input image 310, Moiré pattern 315, and output image 320. In the example of FIG. 3, input image 310 (e.g., a high resolution image) comprises a Moiré pattern 315, and the input image 310 processed (e.g., via computing apparatus 305) to generate output image 320 (e.g., an image with original content of input image 310, with a reduced or removed Moiré pattern). That is, according to the techniques and systems described herein, computing apparatus 305 may process input image 310 to mitigate the impact of the Moiré pattern 315 in the resulting output image 320.

In digital imaging, a pixel (or picture element) refers to the smallest addressable element in a display device, and the smallest controllable element of a picture represented on the device. In some cases, each pixel may represent a sample of an original image. The color and intensity of each pixel is variable. In color imaging systems, a color may be represented by three or four component intensities such as red, green, and blue, or cyan, magenta, yellow, and black.

In digital image processing and computer vision, image correction is the process of editing an image to optimize the appearance of the image. The goal of image correction is to fix imaging problems and improve image quality using a range of editing tools and features. In some cases, image correction may be used to remove image blurriness or patterns (e.g., undesired lines, curves, etc.) in images. In some aspects, corrected images described herein (e.g., output image 320) may be generated using image correction techniques. According to some embodiments of the present disclosure, image correction techniques can be implemented using computing apparatus as described with reference to FIGS. 1-2.

Referring to FIG. 3, an image (e.g., first image 310) is a high-resolution image that includes Moiré pattern 315. For example, first image 310 may be obtained using a tele lens camera that comprises a first sensor having a first optical resolution. In some examples, the tele camera on a user device may be a high-resolution camera including 10 MP 1/3.94″ sensor, 1.0 μm pixels, 36-degree field of view, f/2.4-aperture lens, 3× optical zoom. For example, optical resolution of an imaging system is the system's ability to resolve detail in the environment. The optical resolution is attributed to both the optical system and the camera sensor.

In some cases, a Moiré pattern is formed from television or computer screen image captures (i.e., a single frame and video captured from the presentation of an image via another external display). Moiré patterns are formed when two similar patterns are superimposed on one another to generate a third pattern.

According to one or more aspects of the present disclosure, a Moiré-free image, or a negligible Moiré image, may be captured using a low-resolution image sensor. As described herein, low-resolution image sensors (e.g., low-resolution image cameras, wide angel cameras, ultrawide cameras, etc.) may provide Moiré-free or Moiré reduced images due to physical properties of reduced resolution image capture. For instance, low-resolution image sensors may have more pixels corresponding to each color filter array cell (e.g., multiple pixels may be mapped to cells of a color filter array). For example, low-resolution image sensors may have multiple liquid-crystal display (LCD) pixels corresponding to a single Bayer cell, such that less (e.g., or no) interference may occur, and/or less incorrect color reproduction may occur, that otherwise may result in the appearance of Moiré patterns. Alternatively, high-resolution image sensors may have relatively less pixels corresponding to each color filter array cell (e.g., such as a 1:1 mapping of pixels to CFA cells), which may result in interference, incorrect color reproduction, Moiré pattern, etc.

For example, a low-resolution camera may be an ultra-wide camera that has a low optical resolution due to its large field of view (120 degrees) and large sensor pixel (1.4 μm). In some examples, a low-resolution image sensor may include an ultra-wide camera (e.g., such as a 12 MP 1/2.55″ sensor, 1.4 μm pixels, 120-degree field of view, f/2.2-aperture lens, Dual Pixel AF).

Computing apparatus 305 obtains pixels in the image that correspond to each object or color. Further, computing apparatus 305 detects the Moiré pattern 315 in first image 310 and generates a corrected image based on the detected Moiré pattern. In some examples, computing apparatus 305 may use a correction component (e.g., correction component 230 as described with reference to FIG. 2) to remove the Moiré pattern 315 from first image 310. Computing apparatus 305 is an example of, or includes aspects of, the corresponding element described with reference to FIGS. 1 and 2.

In some cases, image correction (e.g., removal of Moiré pattern 315) may result in generation of a high-resolution output image 320. For example, computing apparatus 305 merges the appropriate colors from the low-resolution image while preserving the details from the high-resolution image to generate output image 320. Output image 320 is an example of, or includes aspects of, the corresponding element described with reference to FIG. 4.

FIG. 4 shows an example of an image processing system 400 according to aspects of the present disclosure. Image processing system 400 is an example of, or includes aspects of, the corresponding element described with reference to FIG. 3. In one aspect, image processing system 400 includes correction component 405, first image sensor 410, second image sensor 415, third image sensor 420, first image 425, second image 430, third image 435, aligned first image 440, aligned second image 445, aligned third image 450, and output image 455.

In the example of FIG. 4, first image 425, second image 430, and third image 435 are used (e.g., input to image processing system, such as correction component 405 of image processing system) to generate a corrected output image 455 (e.g., an image with a reduced or removed Moiré pattern). In some aspects, correction component 405 may include hardware, such as a processor or specialized circuitry, and/or software, such as one or more image processing algorithms.

First image sensor 410, second image sensor 415, and third image sensor 420 may each capture images (e.g., visual information), producing first image 425, second image 430, and third image 435, respectively. Each image sensor may have specific attributes, such as varying resolution, focal length, or sensitivity settings, which can provide different perspectives or levels of detail in the captured images. For instance, first image 425 may be captured via a high resolution image sensor 410 (e.g., a telephoto lens), and the first image 425 may comprise a Moiré pattern 315. Moreover, second image 430 may be captured via a second image sensor 410 (e.g., a wide lens or wide angle camera), and the second image 430 may comprise a reduced (e.g., less apparent, less visual obtrusive) Moiré pattern. Third image 435 may be captured via a low resolution image sensor 420 (e.g., an ultrawide lens or ultrawide angle camera), and the third image 435 may not include a Moiré pattern (e.g., or may include a negligible Moiré pattern).

In some embodiments, the first image 425, second image 430, and third image 435 may be aligned, such that aligned first image 440, aligned second image 445, and aligned third image 450 may be used to reduce or remove any Moiré patterns in generated output images 455. In some aspects, the aligned first image 440, aligned second image 445, and aligned third image 450 may be processed (e.g., cropped, aligned, etc.) versions of the first image 425, second image 430, and third image 435, respectively. In some aspects, the alignment process may involve one or more operations (such as modifying, cropping, repositioning, etc.) to correct for any inconsistencies or discrepancies between the images, such as misalignments or distortions. The alignment may enable effective merging/combination of the images in the next stages of processing (e.g., to remove or reduce any Moiré patterns). For instance, based on the alignment, color and/or edges in the aligned first image 440 and the aligned third image 450 may be compared to identify artifacts such as a Moiré pattern. In some aspects, based on the alignment, regions from different images may be used to generate the output image 455. For example, regions corresponding to a Moiré pattern in aligned first image 440 may be used from the aligned third image 450. Further, regions excluding the Moiré pattern may be used from the aligned first image 440. In such an example, a high resolution, high quality output image 455 may be generated via merging or combination of high resolution regions of aligned first image 440 (that do not include a Moiré pattern) and regions of aligned second image 450 may be used that correspond to the excluded Moiré pattern regions of the aligned first image 440.

Output image 455 is an example of a resulting image produced by the image processing system 400. In certain aspects, the output image 455 may be generated by the correction component 405 via the processing and combining (e.g., merging, fusing, etc.) of the aligned images 440, 445, 450. In some aspects, the output image 455 may offer higher quality/resolution, enhanced detail, improved depth perception, or other benefits derived from the multi-sensor, multi-image approach of the system (e.g., in addition to the output image 455 having reduced or removed image artifacts).

According to an example embodiment of the present disclosure, a user device (e.g., user computing apparatus 110 as described with reference to FIG. 1) may include a first back camera of high-resolution comprising first image sensor 410. In some examples, the high-resolution camera may refer to a tele camera with 1.0 μm pixels, 36-degree field of view, f/2.4-aperture lens, 3× optical zoom. For example, first image sensor 410 may be a 10 MP 1/3.94″ sensor. The first back camera uses first image sensor 410 to obtain first image 425. Referring to FIG. 4, first image 425 includes strong Moiré patterns. First image sensor 410 is an example of, or includes aspects of, the corresponding element described with reference to FIG. 2.

Additionally, the user device may include a second back camera of low-resolution comprising second image sensor 415. In some cases, the user switches the phone camera to a ‘screen capture mode’ when taking a screenshot. In some cases, the low-resolution camera refers to a wide camera that uses second image sensor 415 to obtain second image 430. In some examples, the wide camera may be a primary camera with 1.0 μm pixels, 85-degree field of view, f/1.8-aperture lens, OIS, Dual Pixel AF. For example, second image sensor 415 may be a 10 MP 1/3.94″ sensor. Referring again to FIG. 4, second image 430 includes Moiré patterns that are less strong than the Moiré patterns in first image 425. Second image sensor 415 is an example of, or includes aspects of, the corresponding element described with reference to FIG. 2.

The user device may include a third back camera of low-resolution comprising third image sensor 420. In some cases, the low-resolution camera may be an ultra-wide camera with 1.4 μm pixels, 120-degree field of view, f/2.2-aperture lens, Dual Pixel AF. In some examples, third image sensor 420 is a 12 MP 1/2.55″ sensor. The third back camera uses third image sensor 420 to obtain third image 435. Referring to FIG. 4, third image 435 is a low-resolution image that is free from Moiré patterns. Third image sensor 420 is an example of, or includes aspects of, the corresponding element described with reference to FIG. 2.

A computing apparatus (e.g., computing apparatus 110 and 200 as described with reference to FIGS. 1 and 2) may crop second image 430 and third image 435 based on a field of view of first image 425. Additionally, alignment component (e.g., alignment component 230 of computing apparatus 200 described with reference to FIG. 2) generates an alignment map between the pixels of first image 425, second image 430, and third image 435. For example, alignment component first aligns the matching pixels in each frame pair, i.e., frames of first image 425, second image 430, and third image 435, to generate aligned images. In some examples, alignment component generates aligned first image 440 based on first image 425, aligned second image 445 based on second image 430, and aligned third image 450 based on third image 435, respectively.

As an example shown in FIG. 4, correction component 405 merges the video streams to generate output image 455. In some examples, correction component 405 may merge the correct colors from the ultra-wide camera (e.g., third image 435, aligned third image 450) while preserving the details from the tele camera (e.g., first image 425, aligned first image 440) to generate a high-resolution Moiré-free output image 455. Correction component 405 is an example of, or includes aspects of, the corresponding element described with reference to FIGS. 2 and 5. Output image 455 is an example of, or includes aspects of, the corresponding element described with reference to FIG. 3.

According to an exemplary embodiment, correction component 405 may merge the correct colors from the wide camera (e.g., second image 430, aligned second image 445) while preserving the details from the tele camera (e.g., first image 425, aligned first image 440) to generate a high-resolution Moiré-free output image.

FIG. 4 is shown using three image sensors, and three image capture/image processing pipelines, for illustrative purposes and is not intended to be limiting in terms of the scope of the present disclosure. Generally, any number of image sensors may be used by analogy, without departing from the scope of the present disclosure. For example, in some implementations, a two pipeline approach may be implemented (e.g., on dual camera devices), where two aligned image (e.g., aligned high resolution and low resolution images) may be used to detect and remove Moiré patterns.

FIG. 5 shows an example of a correction component 500 according to aspects of the present disclosure. Correction component 500 is an example of, or includes aspects of, the corresponding element described with reference to FIGS. 2 and 4. According to an embodiment of the present disclosure, correction component 500 includes alignment component 505, artifact detection component 510, and fusion component 515.

In some cases, alignment component 505 crops a low-resolution image based on a field of view of a high-resolution image to obtain a cropped low-resolution image. Further, alignment component 505 aligns the high-resolution image and the cropped low-resolution image. As described with reference to FIGS. 3-4, high-resolution image refers to first image captured by tele camera lens (including the Moiré pattern) and low-resolution image refers to second image captured by ultra-wide camera lens (free from Moiré pattern). For instance, alignment component 505 generates an alignment map between pixels of the high-resolution image and pixels of the low-resolution image. Additionally, an alignment component may align a third image (i.e., third image generated by wide camera lens as described with reference to FIG. 4) with the high-resolution image and the low-resolution image. Alignment component 505 is an example of, or includes aspects of, the corresponding element described with reference to FIG. 2.

According to the embodiments of the present disclosure, artifact detection component 510 detects the Moiré pattern in the high-resolution image. For example, artifact detection component 510 obtains a set of frames of a user-provided video that include the high-resolution image and selects the high-resolution image with the Moiré pattern. In some cases, the high-resolution image is selected based on a detection frequency (e.g., Moiré pattern detection operations, such as alignment, comparison, etc., may be performed once every N video frames according to a configured detection frequency). For example, the detection frequency includes the number of times the pattern is detected in a set of frames. In some examples, the Moiré pattern may not be detected in each frame of the video to reduce processing (e.g., computational costs). Artifact detection component 510 is an example of, or includes aspects of, the corresponding element described with reference to FIG. 2.

In some cases, fusion component 515 generates a corrected image (i.e., a Moiré free frame) from the high-resolution image based on the cropped low-resolution image and the performed alignment. For example, fusion component 515 merges the appropriate colors from the ultra-wide camera (i.e., low-resolution image) while preserving the details from the tele camera (i.e., high-resolution image) to produce a high-resolution Moiré-free image. As an example, correction component 500 includes a neural network.

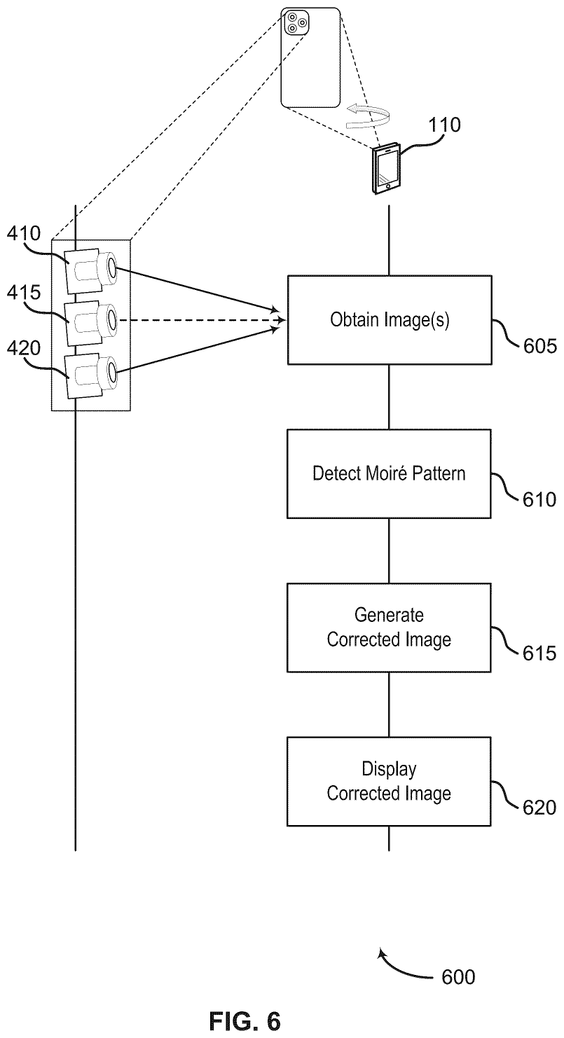

FIG. 6 shows an example of an image correction process 600 according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system sends a set of images. In some cases, the operations of this step refer to, or may be performed by, a user device as described with reference to FIG. 1. In some cases, the operations of this step refer to, or may be performed by, a server as described with reference to FIG. 1. For example, a user may send a set of input images (i.e., a high-resolution image and a low-resolution image) to a server. In some cases, the high-resolution image includes a Moiré pattern.

At operation 610, the system detects a Moiré pattern. For example, in some cases, a Moiré pattern may be detected using a neural network (e.g., a neural network may be trained to identify Moiré pattern based on training data including clean images and images including Moiré pattern image artifacts). Additionally or alternatively, a Moiré pattern may be detected based on a comparison of color and/or edges between images captured from different image sensors (e.g., as described in more detail herein, for example, with reference to FIG. 4). In some cases, the operations of this step refer to, or may be performed by, a user device as described with reference to FIG. 1. In some cases, the operations of this step refer to, or may be performed by, a server as described with reference to FIG. 1.

As an example shown in FIG. 6, the set of images includes a high-resolution image and a low-resolution image with similar content. In some examples, the images may be submitted by the user for correction of the Moiré pattern. In some cases, the user device detects the Moiré pattern in the high-resolution image based on a detection frequency. For example, the user desires to generate a high-resolution de-Moiréd image (e.g., an image without a noticeable Moiré pattern).

At operation 615, the system corrects image. In some cases, the operations of this step refer to, or may be performed by, a computing apparatus as described with reference to FIGS. 1-2. In some cases, the computing apparatus aligns the high-resolution image and the low-resolution image to generate a corrected image. For example, the corrected image refers to the de-Moiréd high-resolution image that is generated based on the input images and the alignment. In some cases, the alignment is performed based on combination of the pixels of the high-resolution image and low-resolution image.

At operation 620, the system returns corrected image. In some cases, the operations of this step refer to, or may be performed by, a computing apparatus as described with reference to FIGS. 1-2. In some cases, the operations of this step refer to, or may be performed by, a server as described with reference to FIG. 1. In some cases, the computing apparatus of the image processing system may generate and return the corrected image to the user. In some cases, the corrected image is generated by removing the Moiré pattern from the high-resolution image using the low-resolution image and the performed alignment. The corrected image includes similar content as the high- and low-resolution images provided by the user.

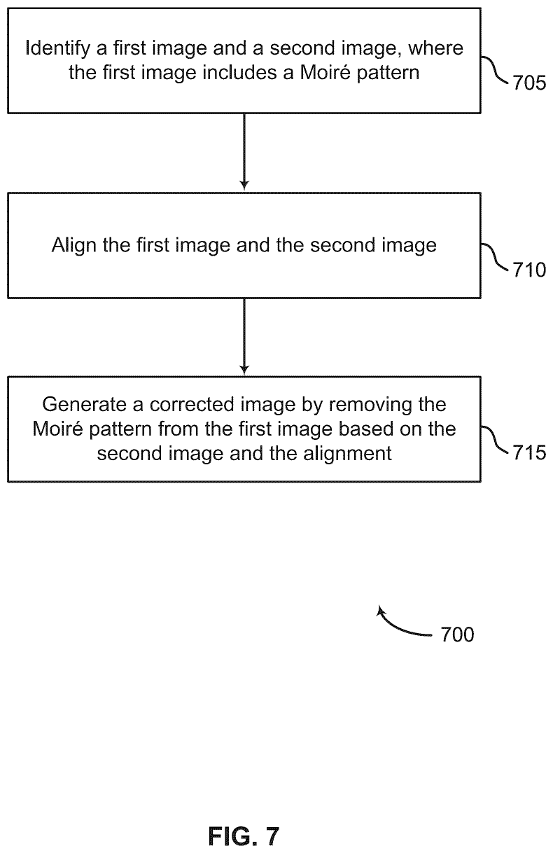

FIG. 7 shows an example of an image processing method 700 according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system identifies a first image and a second image, where the first image includes a Moiré pattern. In some cases, the operations of this step refer to, or may be performed by, a computing apparatus as described with reference to FIGS. 1-3.

According to an embodiment of the present disclosure, first image is a high-resolution image captured using a sensor of the first back camera (i.e., a tele camera lens) of a user device. First image comprises a Moiré pattern. Second image is a low-resolution image captured using a sensor of the second back camera (i.e., an ultra-wide camera lens) of a user device.

Moiré patterns are large-scale interference patterns that can be produced when a partially opaque ruled pattern with transparent gaps is overlaid on another similar pattern. In some cases, when capturing an image of a computer screen, there are two grid patterns, i.e., the color filter on the display (e.g., LCD display) and the color filter on the camera sensor. According to an embodiment, the color filter on the camera sensor includes a Bayer pattern. According to another embodiment, the LCD color filter may be in a stripe arrangement.

According to some embodiments, interference occurs when the optical resolution of a camera is high (e.g., a tele camera lens), so each Bayer cell on the camera sensor collects light emitted from a single LCD pixel. Some of the LCD pixel colors are blocked by the Bayer filter, which causes wrong color reproduction on the camera sensor and the emerging Moiré pattern.

At operation 710, the system aligns the first image and the second image. In some cases, the operations of this step refer to, or may be performed by, an alignment component as described with reference to FIGS. 2 and 5.

According to an embodiment, the high-resolution Moiré pattern image is taken using the tele camera. Additionally, a Moiré-free image is taken with the ultra-wide camera and cropped to match the field of view of the high-resolution image. In some cases, an alignment component first crops the second image based on a field of view of the first image to generate a cropped image. Further, the alignment component aligns the matching pixels in each frame pair. In some cases, the alignment component generates an alignment map between pixels of the first image and pixels of the second image, wherein the corrected image is generated based on the alignment map.

At operation 715, the system generates a corrected image by removing the Moiré pattern from the first image based on the second image and the alignment. In some cases, the operations of this step refer to, or may be performed by, a correction component as described with reference to FIGS. 2, 4, and 5. The correction component (correction component 500 as described with reference to FIG. 5) merges the video streams from the ultra-wide camera. For example, the correction component merges the correct colors from the ultra-wide camera while preserving the details from the higher-resolution camera to produce a high-resolution Moiré-free image.

In some cases, when taking a screenshot, the user switches the phone camera to ‘screen capture mode.’ In this mode, a video stream from the ultra-wide camera is taken in parallel with the stream from the selected high-resolution camera according to the user's zoom preference. In some cases, when the optical resolution of the camera is low (e.g., ultra-wide camera), a single Bayer cell aggregates light from multiple LCD pixels, and no interference occurs. For example, in case of low optical resolution, the color is reproduced correctly. In some cases, the ultra-wide camera has low optical resolution due to its large field of view (120 degrees) and large sensor pixel (1.4 μm). Hence, the Moiré pattern does not appear on screen captures taken with the ultra-wide camera.

Therefore, a method, apparatus, and non-transitory computer readable medium for image processing is described. One or more aspects of the method, apparatus, and non-transitory computer readable medium include identifying a first image and a second image, wherein the first image comprises a Moiré pattern; aligning the first image and the second image; and generating a corrected image by removing the Moiré pattern from the first image based on the second image and the alignment.

Some examples of the method, apparatus, non-transitory computer readable medium, and system further include obtaining the first image using a first sensor having a first resolution. Some examples further include obtaining the second image using a second sensor having a second resolution less than the first resolution.

Some examples of the method, apparatus, non-transitory computer readable medium, and system further include cropping the second image based on a field of view of the first image to obtain a cropped second image, wherein the alignment is based on the cropped second image.

Some examples of the method, apparatus, non-transitory computer readable medium, and system further include generating an alignment map between pixels of the first image and pixels of the second image, wherein the corrected image is generated based on the alignment map.

Some examples of the method, apparatus, non-transitory computer readable medium, and system further include generating an aligned first image based on the first image. Some examples further include generating an aligned second image based on the second image, wherein the corrected image is generated based on the aligned first image and the aligned second image.

Some examples of the method, apparatus, non-transitory computer readable medium, and system further include identifying a third image. Some examples further include aligning the third image with the first image and the second image, wherein the corrected image is generated based on the third image.

Some examples of the method, apparatus, non-transitory computer readable medium, and system further include detecting the Moiré pattern in the first image, wherein the corrected image is generated based on the detection of the Moiré pattern.

Some examples of the method, apparatus, non-transitory computer readable medium, and system further include obtaining a plurality of frames of a video, wherein the plurality of frames includes the first image. Some examples further include selecting the first image from the plurality of video frames based on a detection frequency, wherein the Moiré pattern is detected based on the selection.

Some examples of the method, apparatus, non-transitory computer readable medium, and system further include providing the first image and the second image to a correction neural network, wherein the corrected image is generated by the correction neural network.

An apparatus for image processing is described. One or more aspects of the apparatus include at least one processor; at least one memory storing instructions and in electronic communication with the at least one processor; a first image sensor configured to obtain a first image having a first resolution; a second image sensor configured to obtain a second image having a second resolution different than the first resolution; and a correction component configured to generate a corrected image by removing a Moiré pattern from the first image based on the second image.

Some examples of the apparatus, system, and method further include an alignment component configured to align the first image and the second image, wherein the corrected image is generated based on the alignment.

Some examples of the apparatus, system, and method further include a third image sensor configured to obtain a third image having a third resolution, wherein the alignment component is configured to align the third image with the first image and the second image, and wherein the corrected image is generated based on the third image. In some aspects, the correction component comprises a correction neural network.

Some examples of the apparatus, system, and method further include an artifact detection component configured to detect the Moiré pattern in the first image, wherein the corrected image is generated based on the detection of the Moiré pattern.

### Identical Cameras

According to an exemplary embodiment of the present disclosure, a low-resolution camera may not be provided in the user device. For example, computing apparatus 200 does not include a low-resolution image sensor. Accordingly, each of the image sensors (e.g., first image sensor 215, second image sensor 220, and third image sensor 225 as described with reference to FIG. 2) may comprise a high-resolution camera.

According to the example, two frames from the identical high-resolution cameras may generate different Moiré patterns. The different Moiré patterns may ease finding a clean patch in one of the frames. For example, an embodiment may include two high-resolution (i.e., high optical resolution) cameras that contain the Moiré pattern. In some cases, the Moiré pattern can be at different locations within a frame. Accordingly, the task of extracting clean image patches can be performed from one of the cameras.

According to another embodiment of the present disclosure, a system may be designed to obtain a Moiré-free frame. In some cases, the ultra-wide Moiré-free frame may be cropped and rescaled to generate a final output image. In some cases, the system can be run in real-time on a user device.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
identifying a first image and a second image, wherein the first image comprises a Moiré pattern;
aligning the first image and the second image; and
generating a corrected image by removing the Moiré pattern from the first image based on the second image and the alignment.

2. The method of claim 1, further comprising:
obtaining the first image using a first sensor having a first resolution; and
obtaining the second image using a second sensor having a second resolution less than the first resolution.

3. The method of claim 1, further comprising:
cropping the second image based on a field of view of the first image to obtain a cropped second image, wherein the alignment is based on the cropped second image.

4. The method of claim 1, further comprising:
generating an alignment map between pixels of the first image and pixels of the second image, wherein the corrected image is generated based on the alignment map.

5. The method of claim 1, further comprising:
generating an aligned first image based on the first image; and
generating an aligned second image based on the second image, wherein the corrected image is generated based on the aligned first image and the aligned second image.

6. The method of claim 1, further comprising:
identifying a third image; and
aligning the third image with the first image and the second image, wherein the corrected image is generated based on the third image.

7. The method of claim 1, further comprising:
detecting the Moiré pattern in the first image, wherein the corrected image is generated based on the detection of the Moiré pattern.

8. The method of claim 7, further comprising:
obtaining a plurality of frames of a video, wherein the plurality of frames includes the first image; and
selecting the first image from the plurality of video frames based on a detection frequency, wherein the Moiré pattern is detected based on the selection.

9. The method of claim 8, further comprising:
providing the first image and the second image to a correction neural network, wherein the corrected image is generated by the correction neural network.

10. An apparatus comprising:
at least one processor;
at least one memory storing instructions and in electronic communication with the at least one processor;
the apparatus further comprising a first image sensor configured to obtain a first image having a first resolution;
a second image sensor configured to obtain a second image having a second resolution different than the first resolution; and
a correction component configured to generate a corrected image by removing a Moiré pattern from the first image based on the second image.

11. The apparatus of claim 10, further comprising:
an alignment component configured to align the first image and the second image, wherein the corrected image is generated based on the alignment.

12. The apparatus of claim 11, further comprising:
a third image sensor configured to obtain a third image having a third resolution, wherein the alignment component is configured to align the third image with the first image and the second image, and wherein the corrected image is generated based on the third image.

13. The apparatus of claim 10, wherein:
the correction component comprises a correction neural network.

14. The apparatus of claim 10, further comprising:
an artifact detection component configured to detect the Moiré pattern in the first image, wherein the corrected image is generated based on the detection of the Moiré pattern.

15. A non-transitory computer readable medium storing code for image processing, the code comprising instructions executable by a processor to:
identify a first image and a second image, wherein the first image comprises a Moiré pattern;
align the first image and the second image; and
generate a corrected image by removing the Moiré pattern from the first image based on the second image and the alignment.

16. The non-transitory computer readable medium of claim 15, the code further comprising instructions executable by the processor to:
obtain the first image using a first sensor having a first resolution; and
obtain the second image using a second sensor having a second resolution less than the first resolution.

17. The non-transitory computer readable medium of claim 15, the code further comprising instructions executable by the processor to:
crop the second image based on a field of view of the first image to obtain a cropped second image, wherein the alignment is based on the cropped second image.

18. The non-transitory computer readable medium of claim 15, the code further comprising instructions executable by the processor to:
generate an alignment map between pixels of the first image and pixels of the second image, wherein the corrected image is generated based on the alignment map.

19. The non-transitory computer readable medium of claim 15, the code further comprising instructions executable by the processor to:
generate an aligned first image based on the first image; and
generate an aligned second image based on the second image, wherein the corrected image is generated based on the aligned first image and the aligned second image.

20. The non-transitory computer readable medium of claim 15, the code further comprising instructions executable by the processor to:
identify a third image; and
align the third image with the first image and the second image, wherein the corrected image is generated based on the third image.
